(19) United States
(12) Patent Application Publication
(10) Pub. No.: US 2011/0102597 A1
(43) Pub. Date: May 5, 2011

(54) Millimeter Wave Concealed Object Detection System Using Portal Deployment

(76) Inventors: Robert Patrick Daly, Orlando, FL (US); Willem H. Reinpoldt, III, Windermere, FL (US)

(21) Appl. No.: 12/867,807

(22) PCT Filed: Feb. 17, 2009
(86) PCT No.: PCT/US09/34314

§ 371 Date: Dec. 29, 2010

(51) Int. Cl. H04N 5/30

(52) U.S. Cl. 348/162; 348/E05.085

(57) ABSTRACT

A concealed object detection system using pre-engineered and pre-manufactured components to effectively control the deployment surroundings and provide a known environment in which the equipment can operate. The system provides inherent background/peripheral motion and optical clutter mitigation by virtue of its booth-like design. The system can additionally include x-ray baggage machines, iris scanners, biometrics, finger readers, palm readers, metal detectors, backscatter x-ray, nuclear quadrupole resonance, explosives-trace detectors (“sniffers”), and access control cards.

This Application claims the benefit of U.S. Provisional Application No. 61/028,537, filed Feb. 14, 2008. This application is related to U.S. application Ser. No. 10/618,950, filed Jul. 14, 2003, U.S. application Ser. No. 12/110,520 and U.S. application Ser. No. 12/136,000 filed Jun. 9, 2008. Each of these applications is herein incorporated in its entirety by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of concealed object detection, and in particular to deployment systems for millimeter wave concealed object detection systems.

### BACKGROUND OF THE INVENTION

Containerized access control systems are known in the art for providing a portable container that includes a passing room having two openings for entry and exit with a walkway in-between. However, such access control systems are not suitable for the deployment of concealed object detection systems which include magnetometer or biometric technologies or imaging systems utilizing various forms of energy including millimeter waves, radio waves, visible light, infrared, ultraviolet, and microwave energy.

### SUMMARY OF THE INVENTION

In one embodiment, the disclosed system is an approach for deploying a concealed object detection system using pre-engineered and pre-manufactured components to effectively control the deployment surroundings and provide a known environment in which the equipment can operate. The system provides inherent background/peripheral motion and optical clutter mitigation by virtue of its booth-like design. The system can additionally include x-ray baggage machines, iris scanners, biometrics, finger readers, palm readers, metal detectors, backscatter x-ray, nuclear quadrupole resonance, explosives-trace detectors (“sniffers”), and access control cards.

In one embodiment, the system is a concealed object detection system. The system comprises a housing having an interior and an exterior. The interior of the housing is in open communication with the exterior of the housing through an entrance opening and an exit opening, wherein a subject can enter the interior of the housing though the entrance opening and exit the interior of the housing though the exit opening. The system further comprises at least one millimeter wave camera mounted within the housing, wherein the millimeter wave camera is configured to scan a subject in the interior of the housing. At least one display device is operatively connected to the millimeter wave camera, wherein data obtained by scanning the subject in the interior of the housing is displayed on the display device.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 illustrates an overhead view of a rectangular booth embodiment with single entry/exit point.

FIG. 2 illustrates an overhead view of a rectangular booth embodiment with separate entry/exit points.

FIG. 3A illustrates an overhead view of a cylindrical booth embodiment using one or more stationary, side viewing cameras.

FIG. 3B illustrates an overhead view of a cylindrical booth embodiment wherein the camera is mounted above the subject and utilizes the uniquely curved nature and material of a scanning mirror arm for reflecting the millimeter wave energy from the subject to the camera.

FIG. 3c illustrates an overhead view of a cylindrical booth embodiment wherein a scanning imaging arm directly images the millimeter wave energy from the subject using the numerous sensor elements distributed along the imaging arm

FIG. 4A illustrates an entry view of an ovoid booth, single camera embodiment with complimentary products x-ray baggage machine and metal detector.

FIG. 4B illustrates an overhead view of an ovoid booth, single camera embodiment with complimentary products x-ray baggage machine and metal detector.

FIG. 5 illustrates a multi-booth embodiment housed in a 20′ ISO Conex shipping container.

FIG. 6 illustrates an overhead view of a booth embodiment which contains and integrates complimentary equipment.

FIG. 7 illustrates one embodiment of implementing an automatic bin return feature of x-ray baggage machines.

### DETAILED DESCRIPTION

Reference will now be made in detail to the preferred embodiments of the present invention, examples of which are illustrated in the accompanying drawings.

The disclosed system is an approach for deploying a concealed object detection system using pre-engineered and pre-manufactured components to effectively control the deployment surroundings and provide a known environment in which the equipment can operate. The system provides inherent background/peripheral motion and optical clutter mitigation by virtue of its booth-like design. The system can additionally include x-ray baggage machines, iris scanners, biometrics, finger readers, palm readers, metal detectors, backscatter x-ray, nuclear quadrupole resonance, explosives-trace detectors (“sniffers”), and access control cards.

Embodiments of the system can further allow for a realization of manufacturing, engineering and procurement cost savings due to economies of scale. Furthermore, the system can provides an easy method of removing the deployment from one location and re-deploying in another location.

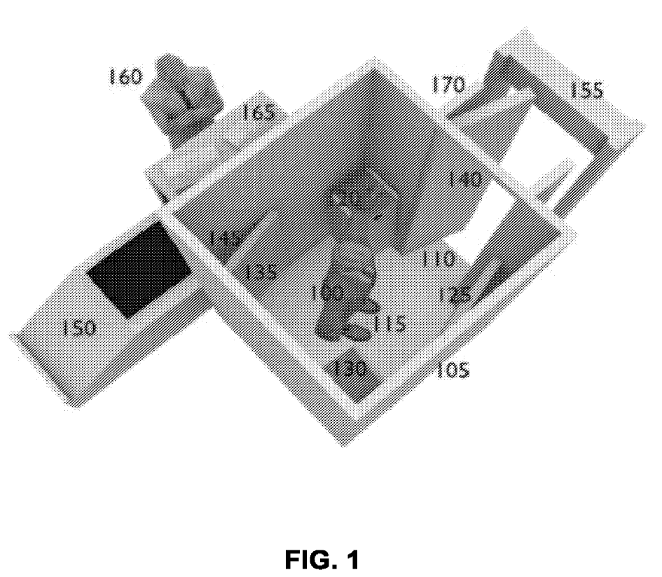

FIG. 1 illustrates an overhead view of a rectangular booth embodiment with single entry/exit point. In this embodiment, a subject 100 enters the booth 105 at entry point 110 and stands in the area designated 115. The subject 100 is then scanned by a millimeter wave camera 120 either directly or indirectly through a flat or curved/focusing reflector 125. The flat or curved/focusing reflector 125 folds the focal length of the millimeter wave optics path allowing for a more compact realization. After successfully imaging one view of the subject 100, the subject 100 can be directed to rotate for additional viewing by the millimeter wave camera 120. The rotate-and-view process can be repeated zero or multiple times. Upon complete imaging, the subject 100 is directed to exit the booth 105 at the common entry/exit point 110.

The booth can also include one or more additional cameras 130, which can use flat or curved/focusing reflectors 135 to image additional views of the subject 100 either sequentially or consecutively with camera 120 to increase the inspection speed, increase the resolution, and/or reduce or eliminate the necessity of subject 100 to rotate in place. The embodiment may optionally include an entry/exit barrier 140 such as a locking door or locking turnstile to restrict the movement of the subject 100 during the scanning process. The barriers may be solenoid-locked and/or magnetically-locked doors, gates and/or turnstiles. The booth can also include complimentary products including, but not limited to, an x-ray baggage machine 150 and metal detector 155, which can be internal or external to the booth 105.

The operation of the booth begins as a subject approaches the booth. If the booth is occupied with a previous subject, the newly arrived subject is directed to wait via an admittance indicator such as red/green indicator lights, computer display screens, graphic icon indicator (arrow versus “x”), locked entry barrier, extended mechanical gate arm, human intervention or another technique. If the booth contains one or more optional x-ray baggage machines with baggage loading points extending outside of the booth proper, the subject may be permitted to load his/her baggage onto the baggage loading point in preparation of entering the booth proper. Separate indicators such as red/green lights, etc., may be positioned at the loading point of each x-ray baggage machine to indicate its status to accept additional baggage depending on the deployment.

When the booth is empty of subjects and ready to admit the next subject, the admittance indicator (if any) will change to indicate admittance is allowed and the subject is permitted to enter the booth proper. If the subject has not already done so and the booth is equipped with one or more x-ray baggage machines, the subject divests himself/herself of any baggage as well as items in his/her possession (keys, lighters, coins, etc.). The subject then enters the booth proper. Upon entry, the admittance indicator (if any) will change to indicate further admittance is not allowed

One or more security personnel 160 can observe the results of the millimeter wave detection 120 and 130, x-ray baggage machine 150 and metal detector 155, together with results of other optional equipment (not shown) on one or more displays 165, and determine if the subject 100 is allowed to exit. These display devices may include, but not be limited to, cathode ray tube (CRT) monitors, plasma or liquid crystal display (LCD) monitors, light emitting diode (LED) displays, and organic LED (OLED) displays.

Embedded into the electronics of the cameras 120 and 130 and/or a separate computing element 145, the programmable logic controller (PLC) functionality would assist and/or replace some or all of the security personnel functionality by directly or indirectly controlling aspects of the inspection process including, but not limited to, direction of the movement of the subject 100, and control of the optional entry/exit barriers 140. The PLC function interfaces to sensors located throughout the disclosed system including, but not limited to, the entry/exit point 110, the imaging point 115, the metal detector 155 and the barrier 140.

The sensors may be proximity, infra-red beam, capacitive, Radio Frequency (RF), inductive, weight/mass sensing or some other suitable technology. The PLC function can also be used to activate or control indicator lights or displays located at the entry to booth 105 to indicate that the booth 105 is ready for the next subject, and at the exit to booth 105 to indicate when the subject 100 is allowed to exit. The construction of the booth 105 may include architecture 170 to restrict or eliminate sources of external visual or millimeter wave energy or distractions within or affecting the view of cameras 120 and 130 or reflectors 125 and 135.

At any time during the aforementioned process, unexpected events may be detected from the sensors and/or components in the booth. Any of these events, or timeouts due to unexpectedly long intervals between steps, are captured by the PLC functionality of the millimeter wave camera(s) and/or dedicated PLC hardware which illuminates a Fault indicator for the operator.

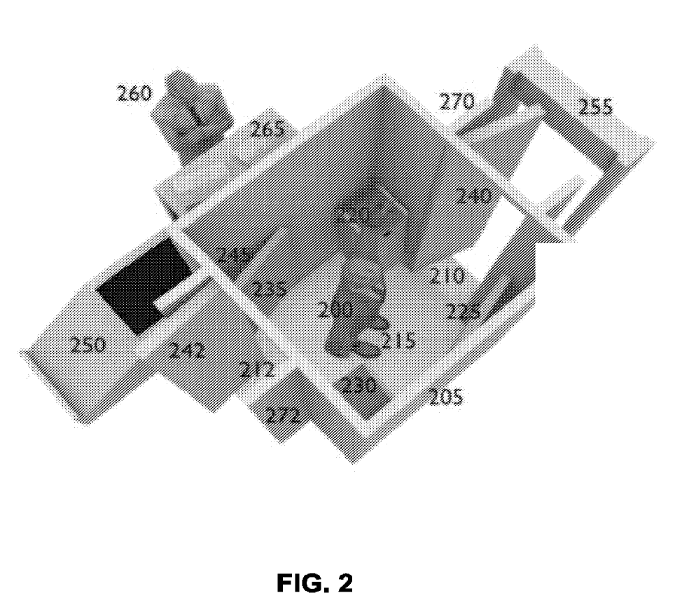

FIG. 2 illustrates an overhead view of a rectangular booth embodiment with separate entry/exit points. A subject 200 enters the booth 205 at entry point 210 and stands in the area designated 215. The subject 200 is then scanned by the millimeter wave camera 220 either directly or indirectly through an optional flat or curved/focusing reflector 225. The reflector 225 fold can the focal length of the millimeter wave optics path allowing for a more compact realization. After successfully imaging one view of the subject 200, the subject 200 would be directed to rotate for additional viewing by the millimeter wave camera 220. The rotate-and-view process may be repeated zero or multiple times. Upon complete imaging, the subject 200 would be directed to exit the booth 205 at the separate exit point 212.

The embodiment may optionally include one or more additional cameras 230, optionally using flat or curved/focusing reflectors 235 to image additional views of the subject 200 either sequentially or consecutively with camera 220 to increase the inspection speed, increase the resolution, and/or reduce or eliminate the necessity of subject 200 to rotate in place. The embodiment may optionally include entry barrier 240 and/or exit barrier 242 such as a locking door or locking turnstile to restrict the movement of the subject 200 during the scanning process.

The embodiment can include complimentary products including, but not limited to, x-ray baggage machine 250 and metal detector 255, internal or external to the booth. One or more security personnel 260 can observe the results of the millimeter wave detection 220 and 240, x-ray baggage machine 250 and metal detector 255, together with results of other optional equipment (not shown) on one or more displays 265, and determine if the subject 200 is allowed to exit.

Embedded into the electronics of the cameras 220 and 230 and/or a separate computing element 245, the programmable logic controller (PLC) functionality would assist and/or replace some or all of the security personnel functionality by directly or indirectly controlling the inspection process including, but not limited to, direction of the movement of the subject 200, and control of the entry barrier 240 and exit barrier 242. The PLC function interfaces to sensors located throughout the disclosed system including, but not limited to, the entry point 210, the exit point 212, the imaging point 215, the metal detector 255, the entry barrier 240, and the exit barrier 242.

The sensors may be proximity, infra-red beam, capacitive, Radio Frequency (RF), inductive, weight/mass sensing or some other suitable technology. The PLC function can also be used to activate or control indicator lights or displays located at the entry to booth 205 to indicate that the booth 205 is ready for the next subject, and at the exit to booth 205 to indicate when the subject 200 is allowed to exit. The construction of the booth 205 may include architecture 270 and 272 to restrict or eliminate sources of external visual or millimeter wave energy or distractions within or affecting the view of cameras 220 and 230 or reflectors 225 and 235.

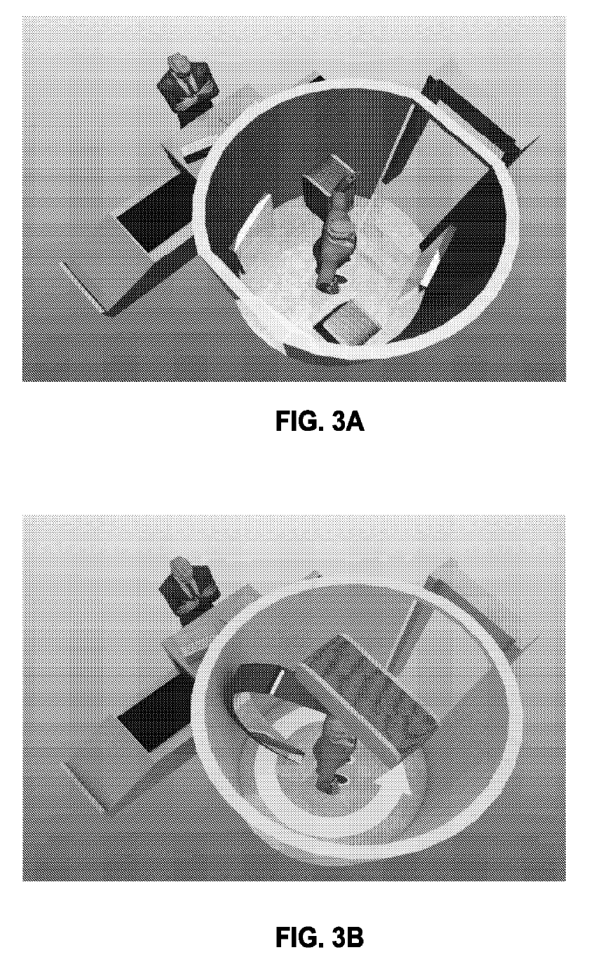

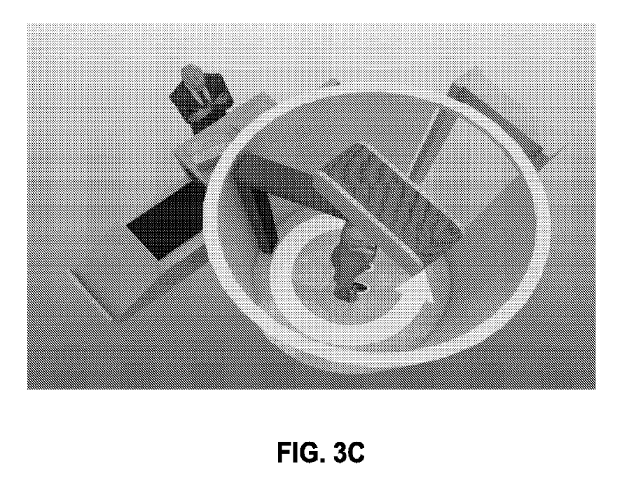

FIG. 3A illustrates an overhead view of a cylindrical booth embodiment using one or more stationary, side viewing cameras. FIG. 3B illustrates an overhead view of a cylindrical booth embodiment wherein the camera is mounted above the subject and utilizes the uniquely curved nature and material of a scanning mirror arm for reflecting the millimeter wave energy from the subject to the camera. The imaging optics and sensor of the millimeter wave camera rotate synchronous with the arm (in one implementation, is directly connected to), and image the reflected helical stripes of the subject's millimeter wave energy as the arm/mirror rotates. By digitally or otherwise combining the individual imaging stripes for a full or partial rotation, the subject is thusly imaged and inspected.

In one embodiment, the rotating arm/mirror uses continuous scanning motion of the rotating mirror arm, in another embodiment the rotating arm/mirror can use non-continuous (start-stop) motion. In another embodiment, multiple arms may be used connected at the center of rotation and separated by evenly distributed angular displacements along the horizontal plane for faster imaging. FIG. 3C illustrates an overhead view of a cylindrical booth embodiment wherein a scanning imaging arm directly images the millimeter wave energy from the subject using the numerous sensor elements distributed along the imaging arm. The imaging arm images the subject's millimeter wave energy as the arm rotates. The camera electronics can be mounted above the subject as depicted in FIG. 3C or mounted in another location. In another embodiment, multiple arms may be used connected at the center of rotation and separated by evenly distributed angular displacements along the horizontal plane for faster imaging.

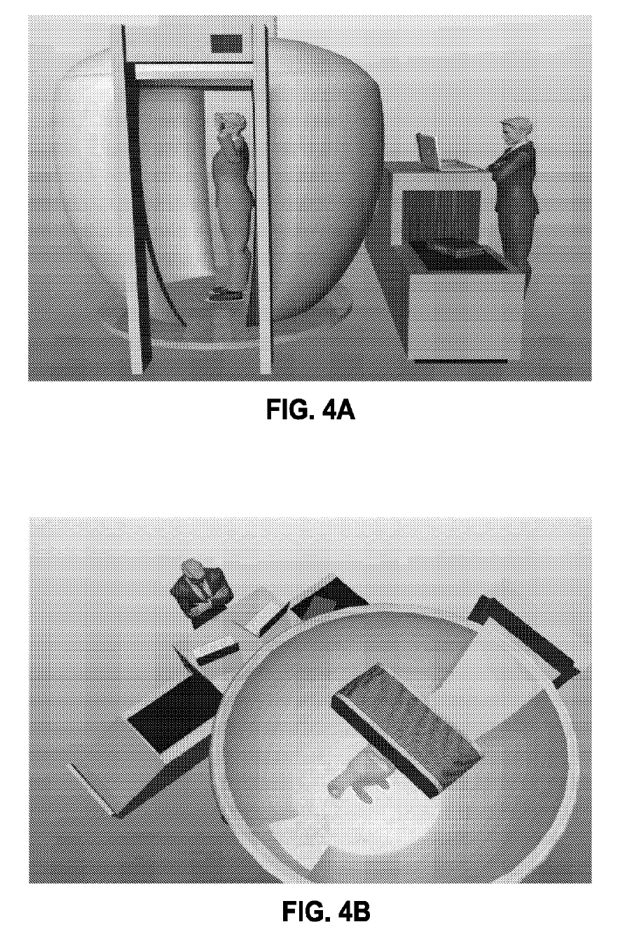

FIGS. 4A and 4B illustrate an entry view and an overhead view, respectively, of an ovoid booth, single camera embodiment with complimentary products x-ray baggage machine and metal detector. In this embodiment, the camera is mounted above the subject and utilizes the uniquely curved nature and material of the booth walls for reflecting the millimeter wave energy from the subject to the camera. Scanning devices including, but not limited to, rotating mirrors and rotating optics, image the reflection of the subject projected onto the curved surfaces of the interior of the booth in a circular fashion. Form-fitting entry and exit barriers (doors) that continue the curve and reflecting nature of the interior walls allows for 360 degree imaging. Otherwise, the portions of the ovoid image corresponding to the entry and exit points would be excluded from the imaging.

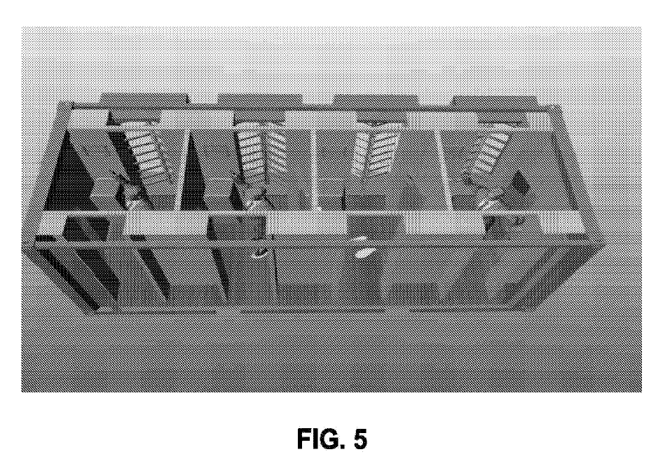

FIG. 5 illustrates a multi-booth embodiment housed in a 20′ ISO Conex shipping container. Each booth can include separate entry/exit points with either entry point, exit point or both, equipped with a barrier preventing entry and/or exit until successful completion of the concealed object detection process. Each booth includes one or more millimeter wave cameras and optional equipment including, but not limited to, x-ray baggage machine, metal detector, in-shoe metal detector and biometric identification. Biometric verification can occur either before, during, after, or in any combination with the concealed object detection process. Biometric verification may include, but not be limited to, fingerprint scanners, hand geometry scanners, facial recognition systems, iris scanners, Radio Frequency Identification (RFID) scanners and access card scanners. The multi-booth embodiment the booths have a common/shared architecture, construction, power distribution, optional heating/cooling, and optional lighting. This can lead to cost savings and reduction of floor space.

In one embodiment, subjects entering an individual booth are then scanned by a millimeter wave camera, either directly or indirectly, through a flat or curved/focusing reflector. The flat or curved/focusing reflector folds the focal length of the millimeter wave optics path allowing for a more compact realization. After successfully imaging one view of the subject, the subject can be directed to rotate for additional viewing by the millimeter wave camera. The rotate-and-view process can be repeated zero or multiple times. Upon complete imaging, the subject 100 is directed to exit the booth.

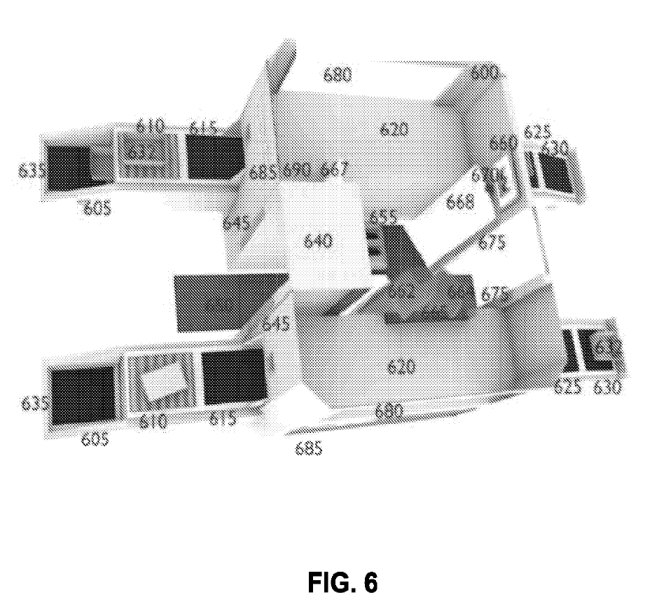

FIG. 6 illustrates an overhead view of a booth embodiment which contains and integrates complimentary equipment. In the illustrated embodiment, the booth 600 contains and integrates complementary equipment such as one or more x-ray baggage machines 620, metal detector 640, in-shoe metal detector 655 and/or facial recognition system 670. The x-ray baggage machine conveyor 605 is completely or partially contained within the booth 600. The x-ray conveyor 605 can include a non-motor driven section 610 for baggage loading and a motor driven section 615 which conveys the baggage or tray 632 into the x-ray baggage machine 620. The x-ray conveyor can include a non-motor driven section 625 for baggage unloading and an automatic tray return mechanism 630 which returns empty trays 632 via a second conveyance to the tray pick-up point 635.

The automatic tray return mechanism 630 is a reversible, tiltable conveyor which pivots at the far end and, at the near end, alternately connects exit conveyor section 625 to the return conveyance leading to pick-up point 635. At some point within or adjacent to the booth 600, a metal detector 640 can be positioned. In one embodiment, the metal detector 640 is positioned near the entrance to the booth 600 and before the concealed object detection camera 662, allowing the concealed objection detection camera 662 to present intelligent decisions about the ferrous nature of the concealed object(s) to the operator.

The booth 600 can include indicator lights, indicators and/or displays 645 signaling whether or not the booth is available for the next subject. Subjects may be directed through the booth using carpets 650, runners, stanchions, cones or other indicators of the required path through the booth 600. At some point within or adjacent to the booth 600, a in-shoe metal detector 655 is positioned. In one embodiment, the in-shoe metal detector 655 is positioned near the center to the booth 600 such that the concealed object detection camera 662 and facial recognition or iris scanner camera 670 may image the subject simultaneous to the in-shoe metal detection process 655.

The concealed object detection may be performed by one millimeter wave camera or more than one camera 664. The camera(s) may be hidden behind material 665 that is completely or partly transparent to millimeter waves. Such material 665 includes, but is not limited to, fabrics, plastics and drywall. The millimeter wave camera 662 (and optionally 664) can employ a flat or curved (focusing) reflector 667 and 668 to fold the focal length of the millimeter wave optics path allowing for a more compact realization. The facial recognition and/or iris scanner camera 670 is can be placed to collect and process images during the time the subject is stationary on the in-shoe metal detector 655 and millimeter wave camera 662. The biometric identification processing for camera 670 can be performed by an on-camera processor 670, by the millimeter wave camera(s) 662 (and 664), or by a separate computing element.

The booth 600 may include lights, indicators and/or displays 675 signaling whether or not the screening process is complete and when the subject is allowed to exit the booth 600. Before, during and/or after the screening process of booth 600, displays 660 can be deployed to instruct the subject on the use of the booth 600. The booth 600 may include architectural elements including, but not limited to, windows 680, portholes, recesses, lettering/logos 685, angular surfaces, or curved surfaces to increase the architectural and aesthetic appeal of the booth and reduce or eliminate user trepidation.

The booth can include alternating entrance permitted indicators for embodiments equipped with multiple x-ray baggage machines. In this embodiment, the slower throughput speeds of each x-ray baggage machine would be offset by deploying multiple x-ray baggage machines per concealed object detection lane. In this case, the alternating entrance permitted indicators would equally direct subjects from the baggage drop-off point of the x-ray baggage machine into the concealed object detection area of the booth, eliminating bottlenecks caused by unequal person distribution between x-ray baggage machines and concealed weapons detection.

The booth 600 may optionally include a PLC element 690 to coordinate and control the various elements of the booth 600, or this function may be relegated to one of the booth computing elements (e.g., millimeter wave camera 662). The PLC function 690 interfaces to sensors located throughout the disclosed system including, but not limited to, the entry point 645 and exit point 675, the imaging point/in-shoe metal detector 655, and the metal detector 640. The sensors may be proximity, infra-red beam, capacitive, Radio Frequency (RF), inductive, weight/mass sensing or some other suitable technology.

The system can include multiple x-ray baggage machines per booth, allowing increased throughput speeds for deployments where the x-ray baggage machine is a slower process in the booth.

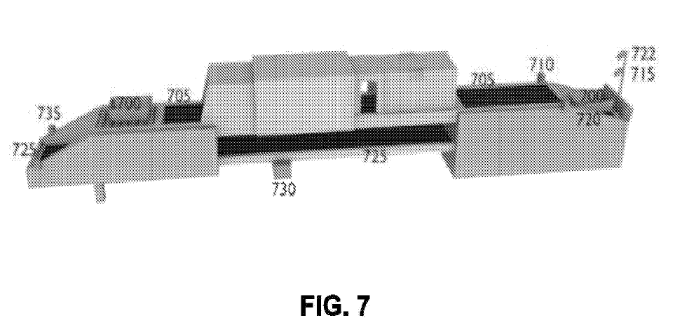

FIG. 7 illustrates one embodiment of implementing an automatic bin return feature of x-ray baggage machines. As the bin 700 approaches the end of the x-ray conveyor 705, a sensor 710 can detect the presence of the bin 700, either using proximity, infra-red light beam, capacitive methodologies. Either sensor 710 or 715 determines that the bin 700 is empty. Sensor 715 may sense either the bin's weight/mass, visual appearance, ultrasonic 3-D profile, laser 3-D profile. The empty bin 700 is conveyed by x-ray conveyor 705 onto a tiltable conveyor 720. Safety sensor 722 may be employed to verify no human is intruding into the operating zone of tiltable conveyor 720. Safety sensor 722 may be an IR light beam curtain, proximity sensor, vision system sensor or some other methodology.

Once the bin 700 is on the tiltable conveyor 720 and safety sensor 722 detects no human intrusion, tiltable conveyor 720 tilts so that the entry edge descends under the horizontal plane of x-ray conveyor 705. Alternately, tiltable conveyor 720 may use a vertical elevator motion or some other motion to cause bin 700 to descend under the horizontal plane of x-ray conveyor 705. Once the tiltable conveyor 720 reaches the end of its vertical motion, as detected by a photo sensor, proximity sensor, encoder, or some other means, its conveyor action restarts in the reverse direction to convey the bin 700 onto a bin return conveyor 725. The bin's 700 departure from and absence on the tiltable conveyor 720 causes the tiltable conveyor 720 to return to its ascended position, ready for the next bin.

The absence of the bin 700 may be sensed via weight sensors, IR light beam sensors, encoder pulses from the tilt conveyor drive axle or some other methodology. Bin return conveyor 725 may be implemented using one continuous conveyor or multiple short conveyors connected in series. The multiple short conveyor approach has the advantage that several bins 700 can be staged along its length in a shift-register fashion. In this case, intelligence in the form of a PLC 730 can control each short conveyor segment independently to convey the bins 700 intelligently back to the front of the x-ray baggage machine. PLC 730 also controls all other actions of the implementation and receives input from its sensors. A sensor 735 at the end of the bin return conveyor 725 detects the presence of an empty bin 700 at the terminating point of the conveyor 725 and signals the conveyor 725, or its last conveyor segment, to stop until the bin 700 is removed and used by the next subject.

Any of the disclosed embodiments can include x-ray baggage machines, metal detectors iris scanners, biometrics, finger readers, palm readers, metal detectors, backscatter x-ray, nuclear quadrupole resonance, explosives-trace detectors (“sniffers”), and access control cards, thus providing a turn-key, multi-tiered security solution. Benefits derived from this include higher levels of integration bringing better performance, easier operation, fewer vendors, cost savings through economies of scale, reduced floor space requirements, streamlined operation and fewer operators. Millimeter wave reflectors/mirrors can be provided either as separate components to the booth or integrated into the structure of the booth in order to extend the view of the camera(s), fold the focal length of the camera(s), or both. The system may include implementations using various forms of energy including millimeter waves, radio waves, visible light, infrared, ultraviolet, microwave energy, etc.

Millimeter wave concealed object detection, in-shoe metal detection, facial recognition and x-ray baggage checking can be performed simultaneously. The operation of the any of the disclosed embodiments during security screening is greatly simplified by virtue of higher levels of component integration. The metal detector, in-shoe metal detector and concealed object detection results can all be displayed on the same operator's display, providing concise, authoritative, detailed, at-a-glance results of the screening process and providing a reduction of operating personnel. Among other things, this can permit operators to leverage the results learned from one detection method to assist or strengthen the results of another detection method. For example, an uncertain and/or intermittent result indicated by the metal detector may be combined with the certain results of the concealed object detection camera(s) to either verify or dismiss the uncertain result.

Any of the disclosed embodiments can include an internal intercom system allowing external security personnel to remotely communicate with subjects inside the booth while viewing the subject via the concealed object detection system's internal CCD camera and/or ancillary cameras or devices, thus providing “stand-off” protection from explosive detonations.

Any of the disclosed embodiments can include air conditioning, heating and/or lighting to improve the operating conditions of the millimeter wave and visible light imaging. Temperature/climate control can be desirable since passive millimeter wave cameras function optimally when there is a temperature contrast between subject and background, and between subject and concealed object. The inclusion of internal lighting improves the performance of the visible light camera. Any of the disclosed embodiments can include blast hatches, stress points, blast resistant/blast containing construction (Kevlar or similar material) or other blast mitigation devices or techniques.

Any of the disclosed embodiments can integrate one or more user display devices to instruct the user on the correct operation and use of the system. A user information display device such as cathode ray tube (CRT) monitor, plasma or liquid crystal display (LCD) monitor, light emitting diode (LED) display, organic LED (OLED) display, or some other device can be positioned in the vicinity of the concealed object detection point to display instructions such as where to stand, where to look, how to orient the body, when to depart, whether or not to return to the booth entry point (object detected), etc.

The instructions can be via single lingual or multi-lingual text, graphics, video, animations or some other means. The instructions may be produced by a video tape recorder, DVD, computer program or some other means. In one embodiment, the user information display can also display an indication of the detection results, conveying to the subject the area or nature of the detection to aid and speed in the subject's divesting of the detected object. Items detected by the concealed object detection or in-shoe metal detector, and/or identity mismatches produced by the biometric device may cause an indicator to signal the subject to return to the entry point of the booth and further divest himself/herself of the detected items.

While the invention has been particularly shown and described with reference to a preferred embodiment thereof, it will be understood by those skilled in the art that various changes in form and details may be made therein without departing from the spirit and scope of the invention. For example, the disclosed system may be used in implementations using various forms of energy including millimeter waves, radio waves, visible light, infrared, ultraviolet, microwave energy, etc

We claim:

1. A concealed object detection system comprising
a housing having an interior and an exterior, wherein the interior is in open communication with the exterior of the housing through an entrance opening and an exit opening, wherein a subject can enter the interior of the housing though the entrance opening and exit the interior of the housing though the exit opening;
at least one millimeter wave camera mounted within the housing, wherein the millimeter wave camera is configured to scan the subject when the subject is positioned in the interior of the housing, wherein the subject is indirectly scanned through a focusing reflector such that the focusing reflector folds a focal length of a millimeter wave optics path of the at least one millimeter wave camera such that a more compact realization of a scanned image is produced; and
at least one display device operatively connected to the at least one millimeter wave camera, wherein the scanned image is displayed by the device.

2. The system of claim 1 wherein entrance opening and the exit opening further comprise an entrance barrier and an exit barrier respectively.

3. The system of claim 2 additionally comprising
at least one programmable logic controller operatively connected to a plurality of sensors associated with the entrance and exit openings, an imaging point, and the entrance and exit barriers.

4. The system of claim 3 wherein each of the plurality of sensors are selected from the list: proximity sensor, infra-red beam sensor, capacitive sensor, Radio Frequency sensor, inductive sensor, weight sensor.

5. The system of claim 3 wherein the at least one programmable logic controller that controls a first indicator display device located at the entrance opening that indicates when the subject is allowed to enter the enclosure, and a second indicator display device at the exit opening that indicates when the subject is allowed to enter the enclosure.

6. The system of claim 1 additionally comprising an x-ray baggage machine and a metal detector, wherein data obtained by scanning a baggage item with the x-ray baggage machine and the metal detector is displayed on the at least one display device.

7. The system of claim 6 additionally comprising an x-ray baggage machine conveyor contained within the housing comprising a non-motor driven section for baggage loading and a motor driven section which conveys the baggage the x-ray baggage machine, and a non-motor driven section for baggage unloading.

8. The system of claim 1 additionally comprising a metal detector positioned near the entrance opening and before the at least one millimeter wave camera.

9. The system of claim 8 additionally comprising an in-shoe metal detector and a biometric identification device, wherein the in-shoe metal detector, the at least one millimeter wave camera, and the biometric identification device are positioned near the center of the interior of the housing such that the in-shoe metal detector, the at least one millimeter wave camera, and a biometric identification device scan the subject at substantially the same time.

10. The system of claim 1 wherein data obtained by scanning the subject with baggage item with the x-ray baggage machine and the metal detector is displayed on the at least one display device. the metal detector, the in-shoe metal detector and the at least one millimeter wave camera is displayed on the at least one display device.

11. The system of claim 1 wherein millimeter wave camera is hidden behind material that at least partly transparent to millimeter waves.

12. The system of claim 1 wherein the subject is directed to the entrance opening using carpets, runners, stanchions, or cones.

13. The system of claim 1 wherein the housing is rectangular.

14. The system of claim 1 wherein the housing is cylindrical.

15. The system of claim 2 wherein entrance the entrance barrier and the exit barrier are turnstiles.

16. A concealed object detection system comprising
a housing having an interior and an exterior, wherein the interior is in open communication with the exterior of the housing through an entrance opening and an exit opening, wherein a subject can enter the interior of the housing though the entrance opening and exit the interior of the housing though the exit opening;
at least one scanning mirror mounted on a scanning mirror arm within the interior of the housing, wherein the at least one scanning mirror is positioned above the subject and the scanning mirror arm is configured to rotate around the subject.
at least one millimeter wave camera mounted within the housing, wherein the at least one millimeter wave camera is configured to rotate synchronously with the scanning mirror arm and to receive at least one reflected helical stripe of the subject's millimeter wave energy from the scanning mirror as the scanning mirror arm rotates, wherein the received at the least one at least one reflected helical stripe is combined to obtain an image of the subject; and
at least one display device operatively connected to the at least one millimeter wave camera, wherein the image is displayed by the device.

17. The system of claim 7 wherein the rotation of the scanning mirror arm and the millimeter wave camera is continuous.

18. The system of claim 7 wherein the rotation of the scanning mirror arm and the millimeter wave camera is non-continuous.

19. The system of claim 7 wherein the at least one scanning mirror comprises a plurality of scanning mirrors mounted on a plurality of scanning mirror arms, wherein the plurality of scanning mirror arms are connected at a center of rotation and are separated by evenly distributed angular displacements along the horizontal plane.

20. A concealed object detection system comprising
a ovoid housing having an interior and an exterior, wherein the interior is in open communication with the exterior of the housing through an entrance opening and an exit opening, wherein a subject can enter the interior of the housing though the entrance opening and exit the interior of the housing though the exit opening;
at least one millimeter wave camera mounted within the housing, wherein the at least one millimeter wave camera is mounted within the interior of the housing above the subject, whereby the at least one millimeter wave camera receives millimeter wave energy from the subject reflected from a curved surface of the interior of the housing, wherein the received millimeter wave energy is processed to obtain an image of the subject;
at least one display device operatively connected to the at least one millimeter wave camera, wherein the scanned image is displayed by the device.

21. The system of claim 11 wherein the at least one millimeter camera comprises a rotating mirror and rotating optics configured to scan an image of a reflection of the subject projected onto the curved surface of the interior of the housing in a circular fashion.

22. The system of claim 12 additionally comprising a first form-fitting barrier to the entrance opening and a second form-fitting barrier to the exit opening.

23. A concealed object detection system comprising:
a housing, comprising:
a plurality of compartments, wherein each compartment has an exterior and an interior, wherein each compartment is in open communication with the exterior of the housing through an entrance opening and an exit opening, wherein a subject can enter the interior of the compartment though the entrance opening and exit the interior of the compartment though the exit opening;
at least one millimeter wave camera mounted within each of the plurality of compartments, wherein each millimeter wave camera is configured to scan the subject when the subject is positioned in the interior of the compartments, wherein the subject is indirectly scanned through a focusing reflector such that the focusing reflector folds a focal length of a millimeter wave optics path of the at least one millimeter wave camera such that a more compact realization of a scanned image is produced; and
at least one display device operatively connected to each of the at least one millimeter wave cameras, wherein data obtained by scanning the subject in the interior of the compartment is displayed on at least one display device,
wherein compartments have common power distribution, heating and cooling, and lighting.

24. The system of claim 23 wherein the housing is a shipping container.
